(19) United States
(12) Patent Application Publication
(10) Pub. No.: US 2015/0074144 A1
(43) Pub. Date: Mar. 12, 2015

(54) Method, Device, and System for Discovering Machine to Machine Service

(71) Applicant: Huawei Device Co., Ltd., Shenzhen (CN)

(72) Inventors: Jun Zhang, Beijing (CN); Guodong Xue, Shenzhen (CN)

(21) Appl. No.: 14/539,046

(22) Filed: Nov. 12, 2014

Related U.S. Application Data
(63) Continuation of application No. PCT/CN2013/081340, filed on Aug. 13, 2013.

(30) Foreign Application Priority Data
Aug. 13, 2012 (CN) 201210286544.X

(51) Int. Cl. H04L 29/08; G06F 17/30

(52) U.S. Cl. CPC H04L 67/16; G06F 17/30864
USPC 707/770

(57) ABSTRACT

A method, a device, and a system are provided. The method includes: receiving, by a first device, a second device registration request sent by a second device, where the second device registration request carries description information of the second device; creating, by the first device, a first resource, and storing the description information of the second device; returning a response indicative of a registration success of the second device to the second device, so that the second device sends a machine to machine (M2M) service registration request to the second device; receiving, by the first device, the M2M service registration request, where the M2M service registration request carries description information of an M2M service supported by the second device; creating, by the first device, a second resource corresponding to the first resource, and storing the description information of the M2M service supported by the second device.

### CROSS-REFERENCE TO RELATED APPLICATIONS

This application is a continuation of International Application No. PCT/CN2013/081340, filed on Aug. 13, 2013, which claims priority to Chinese Patent Application No. 201210286544.X, filed on Aug. 13, 2012, both of which are incorporated herein by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of network technologies, and in particular, to a method, a device, and a system for discovering a machine to machine (M2M) service.

### BACKGROUND

M2M communications is a service mode that connects various terminal devices by using a plurality of communications technologies and summarizes the terminal devices on an M2M server to implement terminal device management and service, so that M2M services provided by the M2M server such as fleet management, automatic meter reading, health surveillance, or environmental monitoring may conveniently acquire various information needed from the terminal devices, thereby improving the working efficiency, reducing manpower costs, and bringing more flexibility and novelty.

A communications scenario for implementing the M2M service may be an M2M device on a terminal side accesses a communications network (such as the Internet or a mobile communications network) by means of an M2M gateway to implement communication with an M2M server that is deployed on the network side and can provide the M2M service, thereby implementing various M2M services.

For example, based on the foregoing communications scenario, an implementation process of an automatic meter reading service in a public services field such as water supply, electricity supply, and natural gas supply may be a metering device with a sensor such as an electricity meter, a water meter, or a natural gas meter may automatically read data on the metering device on a specified date or within a specified period of time, and transmits the data to a data center of an electric power company, water supply company, or natural gas company by means of a wireless network, and then the data center uniformly applies and processes the received data. In this way, previously complicated and effort-consuming meter reading at a user's home becomes very simple. Not only a large quantity of human resources are saved and a working efficiency is improved, but also an application amount change in the public services field can be accurately acquired, so as to timely adjust supply.

Based on the foregoing communications scenario, an implementation process of a vehicle management service widely applied such industries as a logistic company and retail business may be a vehicle installed with a sensor may transfer a large amount of useful information such as speed, location, and mileage to a data center of a company by means of the wireless network in real time, so that the company may control a current situation of a fleet in real time according to returned information. In addition, information returned by the vehicle may be further stored and analyzed, so as to be applied for other purposes, such as route planning and vehicle dispatching.

Based on the foregoing communications scenario, an implementation process of an environmental monitoring service mainly applied in an environment-related field may be environment monitoring instruments distributed in various locations may transfer detected weather conditions, such as temperature, humidity, and pollution level to an environmental protection department by means of the wireless network in real time, so that the environmental protection department may inform the public of the weather conditions timely according to received data and analyze a root cause by using recorded data.

Then, to enable various M2M services to possess resources and capabilities of accessing and using the communications network, the European Telecommunications Standards Institute (ETSI) Technical Committee (TC) M2M defines such service capabilities as generic communication capability, application enablement capability, or data storage capability that are possessed by such network entities as the M2M device, M2M gateway, or M2M server as an M2M service capability layer (M2M SCL). The M2M SCL may specifically be an M2M device service capability layer (M2M DSCL) located in the M2M device, an M2M gateway service capability layer (M2M GSCL) located in the M2M gateway, and an M2M network service capability layer (M2M NSCL) located in the M2M server.

An existing standard proposes a method for discovering an M2M service in a case of a same M2M network domain and only one M2M NSCL exists in the M2M network domain. Specifically, the ETSI Technical Specification (TS) 102 690 proposes that: to implement management on the M2M service by the M2M SCL, the M2M service needs to register with the M2M SCL, that is, the M2M DSCL, M2M GSCL, or M2M NSCL. After accepting an M2M service registration, the M2M SCL stores related M2M service information on the M2M SCL and provides the M2M service to the user. In this way, the user can query and obtain the corresponding M2M service from the M2M NSCL.

However, with the development of the M2M communications, a plurality of M2M NSCLs may exist within a same M2M network domain, and a plurality of M2M network domains may appear. Therefore, different service providers can choose to register the M2M service in M2M NSCLs in a same M2M domain, or choose to register the M2M service in M2M NSCLs in different M2M domains For these two situations, because the M2M service is registered in a plurality of M2M NSCLs, a solution of discovering an M2M service provided by different M2M NSCLs in the same M2M network domain and an M2M service provided by the M2M NSCLs in different M2M network domains needs to be provided. However, the prior art and the existing standard do not provide a corresponding solution.

### SUMMARY

To address the problem in the prior art, embodiments of the present invention provide a method, a device, and a system for discovering an M2M service. Technical solutions are as follows.

According to one aspect, an embodiment of the present invention provides a method for discovering an M2M service, and the method includes: receiving, by a first device, a second device registration request sent by a second device, where the second device registration request carries description information of the second device; creating, by the first device, a first resource, and storing the description information of the second device; returning, by the first device a response indicative of a registration success of the second device to the second device, so that the second device sends an M2M service registration request to the second device after receiving the response indicative of the registration success of the second device; receiving, by the first device, the M2M service registration request, where the M2M service registration request carries description information of an M2M service supported by the second device; and creating, by the first device, a second resource corresponding to the first resource, and storing the description information of the M2M service supported by the second device, so that an M2M service requester discovers the M2M service according to the description information of the second device and the description information of the M2M service supported by the second device.

The description information of the second device includes identification information of the second device, where the identification information includes at least one of: access uniform resource indicator (URI) information, a device identifier, and an Internet Protocol (IP) address.

The description information of the second device further includes at least one of a name of the second device and information about an M2M network domain to which the second device belongs.

The description information of the M2M service includes identification information of the M2M service.

The description information of the M2M service further includes at least one of: a name of the M2M service, provider information of the M2M service, a type of the M2M service, service area information of the M2M service, quantity of service users of the M2M service, and a billing standard of the M2M service.

The second device registration request or the M2M service registration request further carries at least one of: address information and identification information of an M2M register machine generic communication RGC capability layer.

According to another aspect, an embodiment of the present invention further provides a device for discovering an M2M service, and the device includes a first receiving module, a first resource creating module, a sending module, a second receiving module, and a second resource creating module.

The first receiving module is configured to receive a second device registration request sent by a second device, and the second device registration request carries description information of the second device.

The first resource creating module is configured to create a first resource and store the description information of the second device.

The sending module is configured to return a response indicative of a registration success of the second device to the second device, so that the second device sends an M2M service registration request to the second device after receiving the response indicative of the registration success of the second device.

The second receiving module is configured to receive the M2M service registration request, and the M2M service registration request carries description information of an M2M service supported by the second device.

The second resource creating module is configured to create a second resource corresponding to the first resource and store the description information of the M2M service supported by the second device, so that an M2M service requester discovers the M2M service according to the description information of the second device and the description information of the M2M service supported by the second device.

An embodiment in this aspect provides a system for discovering an M2M service, and the system includes a first device and a second device.

The second device is configured to send a second device registration request to the first device, and the second device registration request carries description information of the second device.

The first device is configured to: when receiving the second device registration request, create a first resource, store the description information of the second device, and return a response indicative of a registration success of the second device to the second device.

The second device is further configured to send an M2M service registration request to the first device after receiving the response indicative of the registration success of the second device, where the M2M service registration request carries description information of an M2M service supported by the second device.

The first device is configured to: when receiving the M2M service registration request, create a second resource corresponding to the first resource, and store the description information of the M2M service supported by the second device, so that an M2M service requester discovers the M2M service according to the description information of the second device and the description information of the M2M service supported by the second device.

Moreover, an embodiment of the present invention provides a method for discovering an M2M service, and the method includes: receiving, by a first device, a service query message sent by an M2M service requester, where the service query message carries a query criterion; querying, by the first device and according to the query criterion, description information of a locally stored M2M service to obtain description information of an M2M service that matches the query criterion; and returning, by the first device at least one of description information of the queried M2M service and description information of the second device that supports the queried M2M service to the M2M service requester, so that the M2M service requester acquires service data of the queried M2M service from the second device or uses the queried M2M service.

The returning, by the first device, at least one of description information of the queried M2M service and description information of the second device that supports the queried M2M service to the M2M service requester includes: querying, by the first device and according to the description information of the queried M2M service, description information of a locally stored second device that supports the M2M service to obtain the second device that supports the queried M2M service, and then returning the description information of the queried M2M service and the description information of the second device that supports the queried M2M service to the M2M service requester; alternatively, when the second device that supports the M2M service and the first device are located in a same device, directly returning, by the first device the description information of the queried M2M service to the M2M service requester; alternatively, returning the description information of the queried M2M service to the M2M service requester, so that the second device sends a second device acquiring request to the first device after receiving the description information of the queried M2M service; receiving the second device acquiring request, where the second device acquiring request is used to request the second device that supports the queried M2M service, and the second device acquiring request carries identification information of the queried M2M service; querying, according to the identification information, description information of a locally stored second device that supports the M2M service to obtain the second device that supports the queried M2M service; and returning the description information of the second device that supports the queried M2M service to the M2M service requester.

The query criterion includes at least one of: a name of an M2M service for which query is requested, an identifier of the M2M service for which query is requested, provider information of the M2M service for which query is requested, a type of the M2M service for which query is requested, service area information of the M2M service for which query is requested, quantity of service users of the M2M service for which query is requested, and a billing standard of the M2M service for which query is requested.

The description information of the M2M service includes identification information of the M2M service.

The description information of the M2M service further includes at least one of: a name of the M2M service, provider information of the M2M service, a type of the M2M service, service area information of the M2M service, quantity of service users of the M2M service, and a billing standard of the M2M service.

The description information of the second device includes identification information of the second device, where the identification information includes at least one of: access URI information, a service capability layer (SCL) identifier, and an IP address.

The description information of the second device further includes at least one of: a name of the second device and information about an M2M network domain to which the second device belongs.

The service query message further carries at least one of: address information and identification information of an M2M register machine application enablement registry application enablement (RAE) capability layer.

The acquiring, by the M2M service requester, service data of the queried M2M service from the second device, or using the queried M2M service includes: receiving, by the second device, an M2M service data acquiring request sent by the M2M service requester; and querying, by the second device, a latest contentInstance in a locally stored resource container corresponding to the queried M2M service, and sending the latest contentInstance to the M2M service requester.

The acquiring, by the M2M service requester, service data of the queried M2M service from the second device, or using the queried M2M service includes: receiving, by the second device, an M2M service data subscription request sent by the M2M service requester, where the M2M service data subscription request carries subscription information; creating, by the second device, a subscription resource to store the subscription information; and feeding back, by the second device, an updated contentInstance to the M2M service requester by using a subscription feedback address in the subscription information when the contentInstance in the locally stored resource container corresponding to the queried M2M service is updated.

Before the acquiring, by the M2M service requester, service data of the queried M2M service from the second device, or using the queried M2M service, the method further includes: receiving, by the second device, a registration request sent by the M2M service requester; and locally creating, by the second device, a resource corresponding to the M2M service requester.

An embodiment of the present invention provides a device for discovering an M2M service. The device includes: a first receiving module, a first querying module, and an information feedback module.

The first receiving module is configured to receive a service query message sent by an M2M service requester, and the service query message carries a query criterion.

The first querying module is configured to query, according to the query criterion, description information of a locally stored M2M service to obtain description information of an M2M service that matches the query criterion.

The information feedback module is configured to return at least one of description information of the queried M2M service and description information of the second device that supports the queried M2M service to the M2M service requester, so that the M2M service requester acquires service data of the queried M2M service from the second device or uses the queried M2M service.

The information feedback module includes: a first information feedback unit configured to query, according to the description information of the queried M2M service, the description information of the locally stored second device that supports the M2M service to obtain the second device that supports the queried M2M service, and then return the description information of the queried M2M service and the description information of the second device that supports the queried M2M service to the M2M service requester; alternatively, a second information feedback unit configured to: when the second device that supports the M2M service and the first device are located in a same device, directly return the description information of the queried M2M service to the M2M service requester; alternatively, a third information feedback unit configured to: return the description information of the queried M2M service to the M2M service requester, so that the second device sends a second device acquiring request to the first device after receiving the description information of the queried M2M service; receive the second device acquiring request, where the second device acquiring request is used to request and obtain the second device that supports the queried M2M service, and the second device acquiring request carries identification information of the queried M2M service; query, according to the identification information, description information of a locally stored second device that supports the M2M service to obtain the second device that supports the queried M2M service; and return the description information of the second device that supports the queried M2M service to the M2M service requester.

An embodiment of the present invention provides a system for discovering an M2M service. The system includes an M2M service requester and a first device.

The M2M service requester is configured to send a service query message to the first device, and the service query message carries a query criterion.

The first device is configured to query, according to the query criterion, description information of a locally stored M2M service to obtain the description information of an M2M service that matches the query criterion, and return at least one of description information of the queried M2M service and description information of a second device that supports the queried M2M service to the M2M service requester, so that the M2M service requester acquires service data of the queried M2M service from the second device or uses the queried M2M service.

The system further includes a second device, where the second device includes: a first receiving module configured to receive an M2M service data acquiring request sent by the M2M service requester; and a first data feedback module configured to query a latest contentlnstance in a locally stored resource container corresponding to the queried M2M service, and send the latest contentInstance to the M2M service requester.

The system further includes a second device, where the second device includes: a second receiving module configured to receive an M2M service data subscription request sent by the M2M service requester, and the M2M service data subscription request carries subscription information; a first resource creating module configured to create a subscription resource to store the subscription information; and a second data feedback module configured to feed back an updated contentlnstance to the M2M service requester by using a subscription feedback address in the subscription information when the contentlnstance in the locally stored resource container corresponding to the queried M2M service is updated.

The system further includes a second device, where the second device includes: a third receiving module configured to receive a registration request sent by the M2M service requester; and a second resource creating module configured to locally create a resource corresponding to the M2M service requester.

Beneficial effects achieved in the embodiment of the present invention are as follows: by means of receiving the second device registration request and the M2M service registration request sent by the second device and storing the description information of the second device and the description information of the M2M service supported by the second device, the M2M service requester (an M2M user, an M2M application, or the first device) discovers the M2M service according to the description information of the second device and the description information of the M2M service supported by the second device stored by the first device.

### BRIEF DESCRIPTION OF THE DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1A is a schematic flowchart of a method for discovering an M2M service according to Embodiment 1 of the present invention;

FIG. 1B is a schematic flowchart of a method for discovering an M2M service according to Embodiment 1 of the present invention;

FIG. 2 is a schematic diagram of an M2M network architecture according to Embodiment 1 of the present invention;

FIG. 3 is a schematic flowchart of a method for discovering an M2M service according to Embodiment 1 of the present invention;

FIG. 4 is an M2M registry service capabilities layer (RSCL) Tree according to Embodiment 1 of the present invention;

FIG. 5 is a schematic flowchart of a method for discovering an M2M service according to Embodiment 1 of the present invention;

FIG. 6 is a schematic flowchart of a method for acquiring data information of a queried M2M service according to Embodiment 1 of the present invention;

FIG. 7 is a schematic flowchart of a method for acquiring data information of a queried M2M service according to Embodiment 1 of the present invention;

FIG. 8 is a schematic structural diagram of a device for discovering an M2M service according to Embodiment 2 of the present invention;

FIG. 9 is a schematic structural diagram of a device for discovering an M2M service according to Embodiment 3 of the present invention;

FIG. 10 is a schematic structural diagram of a system for discovering an M2M service according to Embodiment 4 of the present invention;

FIG. 11 is a schematic structural diagram of a device for discovering an M2M service according to Embodiment 5 of the present invention;

FIG. 12 is a schematic structural diagram of a device for discovering an M2M service according to Embodiment 6 of the present invention;

FIG. 13 is a schematic structural diagram of a device for discovering an M2M service according to Embodiment 6 of the present invention;

FIG. 14 is a schematic diagram of a system for discovering an M2M service according to Embodiment 7 of the present invention;

FIG. 15 is a schematic diagram of a system for discovering an M2M service according to Embodiment 7 of the present invention;

FIG. 16 is a schematic diagram of a system for discovering an M2M service according to Embodiment 7 of the present invention; and

FIG. 17 is a schematic diagram of a system for discovering an M2M service according to Embodiment 7 of the present invention.

### DETAILED DESCRIPTION

To make the objectives, technical solutions, and advantages of the present invention clearer, the following further describes the embodiments of the present invention in detail with reference to the accompanying drawings.

### Embodiment 1

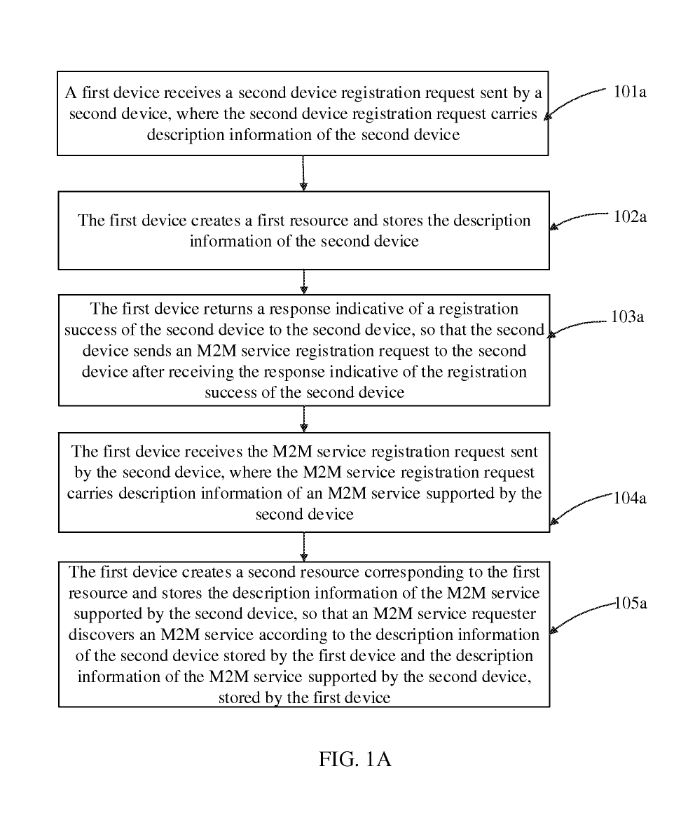

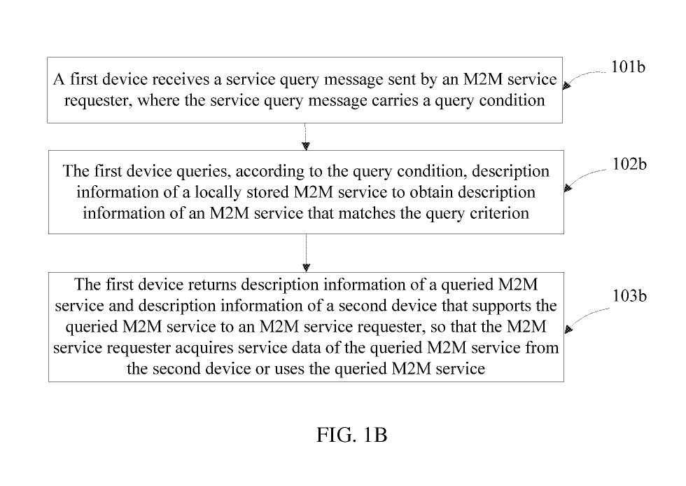

Referring to FIG. 1A, a method for discovering an M2M service includes:

Step 101a: A first device receives a second device registration request sent by a second device, where the second device registration request carries description information of the second device.

Step 102a: The first device creates a first resource and stores the description information of the second device.

Step 103a: The first device returns a response indicative of a registration success of the second device to the second device, so that the second device sends an M2M service registration request to the second device after receiving the response indicative of the registration success of the second device.

Step 104a: The first device receives the M2M service registration request sent by the second device, where the M2M service registration request carries description information of an M2M service supported by the second device.

Step 105a: The first device creates a second resource corresponding to the first resource and stores the description information of the M2M service supported by the second device, so that an M2M service requester discovers the M2M service according to the description information of the second device stored by the first device and the description information of the M2M service supported by the second device.

A beneficial effect achieved in the embodiment of the present invention is: by means of receiving a second device registration request and an M2M service registration request sent by the second device and storing description information of the second device and description information of an M2M service supported by the second device, an M2M service requester (an M2M user, an M2M application, or a first device) discovers an M2M service according to description information of a second device stored by the first device and the description information of the M2M service supported by the second device.

Referring to FIG. 1B, a method for discovering an M2M service is provided and includes:

Step 101b: A first device receives a service query message sent by an M2M service requester, where the service query message carries a query criterion.

Step 102b: The first device queries, according to the query criterion, description information of a locally stored M2M service to obtain description information of an M2M service that matches the query criterion.

Step 103b: The first device returns description information of a queried M2M service and description information of a second device that supports the queried M2M service to the M2M service requester, so that the M2M service requester acquires service data of the queried M2M service from the second device or uses the queried M2M service.

A beneficial effect achieved in the embodiment of the present invention is: description information of a locally stored M2M service is queried according to a query criterion in a service query message sent by an M2M service requester, and description information of an M2M service that matches the query criterion is obtained; and then, description information of a queried M2M service and description of a second device that supports the queried M2M service are returned to the M2M service requester, so that the M2M service requester can acquire service data of the queried M2M service from a queried M2M NSCL.

In the embodiment of the present invention, the first device described above may specifically be an M2M registry, and preferentially, during a specific process of discovering an M2M service, the first device may specifically be an M2M RSCL; the second device described above may specifically be an M2M network entity, for example, an M2M device, an M2M gateway, or an M2M server, and preferentially, during a process of discovering an M2M service, the second device specifically can be an M2M SCL in the M2M network entity, where the M2M SCL may specifically be an M2M DSCL located in the M2M device, an M2M GSCL located in the M2M gateway, or an M2M NSCL located in the M2M server.

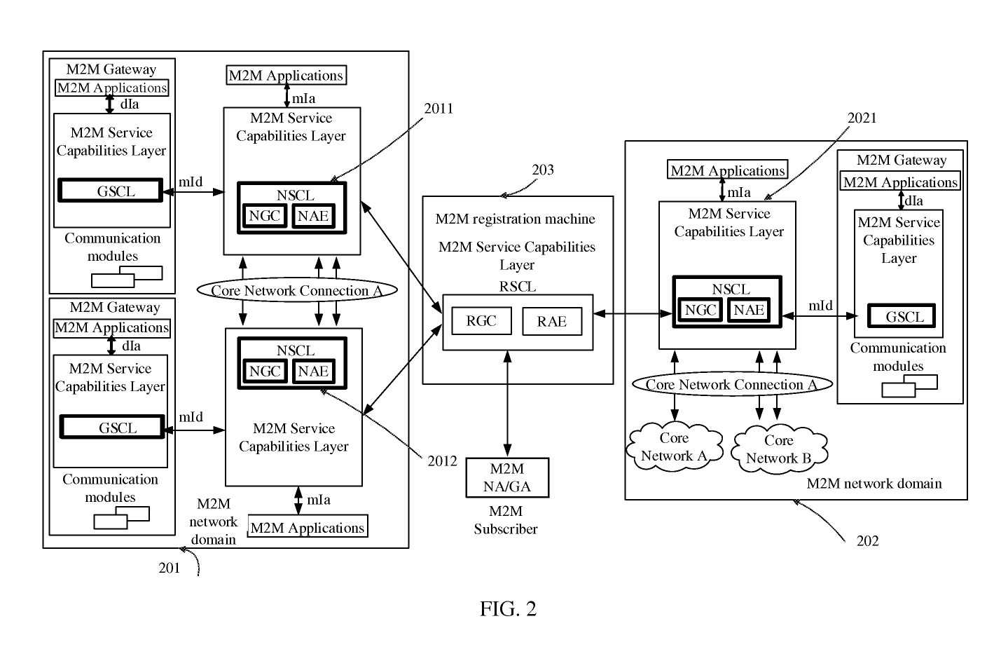

That the M2M RSCL is the first device and the M2M NSCL in the M2M SCL is the second device is used as an example in the embodiment of the present invention to describe the technical solutions illustrated in FIG. 1 and FIG. 2 in detail. However, when the first device and second device specifically are other entities described above, the method for discovering an M2M service is the same as this method, which is not further described herein. A specific method is described as follows.

For an instance of the M2M network architecture corresponding to the embodiment of the present invention, refer to FIG. 2. FIG. 2 includes two different M2M network domains, that is, an M2M network domain 201 and an M2M network domain 202, and an M2M registry 203. The M2M network domain 201 includes two different M2M NSCLs, that is, an M2M NSCL 2011 and an M2M NSCL 2012, and the M2M network domain 202 includes one M2M NSCL, that is, an M2M NSCL 2021.

Here, the M2M NSCL is located in the M2M server and includes a network generic communication (NGC) capability layer and a network application enablement (NAE) capability layer, where the RGC can provide a information registration service of the M2M service and the RAE can provide a query service of the M2M service.

It should be noted that, before the technical solution provided by the present invention is implemented, the M2M service may be directly registered in the M2M NSCL over an mIa interface and can further be registered with the M2M GSCL on the M2M network over a dIa interface. Afterwards, the registered M2M service in the M2M GSCL is registered with the M2M NSCL over the mIa interface. The M2M NSCL stores registration information of the M2M service and may receive, store, or process M2M service data reported by the M2M device, to provide the M2M service to a user. The dIa interface is an interface between the M2M service and the M2M GSCL and is defined in the ETSI TS 102 921; the mIa interface is an interface between the M2M service and the M2M NSCL and is defined in the ETSI TS 102 921.

In the embodiment of the present invention, an M2M registry 203 supports an M2M SCL defined by the ETSI TC M2M. Herein, a service capability supported by the M2M registry is defined as an M2M RSCL. The M2M RSCL includes a registry generic communication (RGC) capability layer and an RAE capability layer, where the RGC provides the information registration service of the M2M service and the RAE provide the query service of the M2M service.

Based on the foregoing network architecture, a general idea of the method for discovering an M2M service provided by the present invention may be: different M2M NSCLs in the same M2M network domain or the M2M NSCLs in different M2M network domains can separately register M2M NSCL information and M2M service information supported by the M2M NSCL with the M2M RSCL. In this way, an M2M application or an M2M user can query the registered M2M NSCLs and M2M service information on the M2M RSCL to discover the M2M service and acquire the corresponding M2M service data.

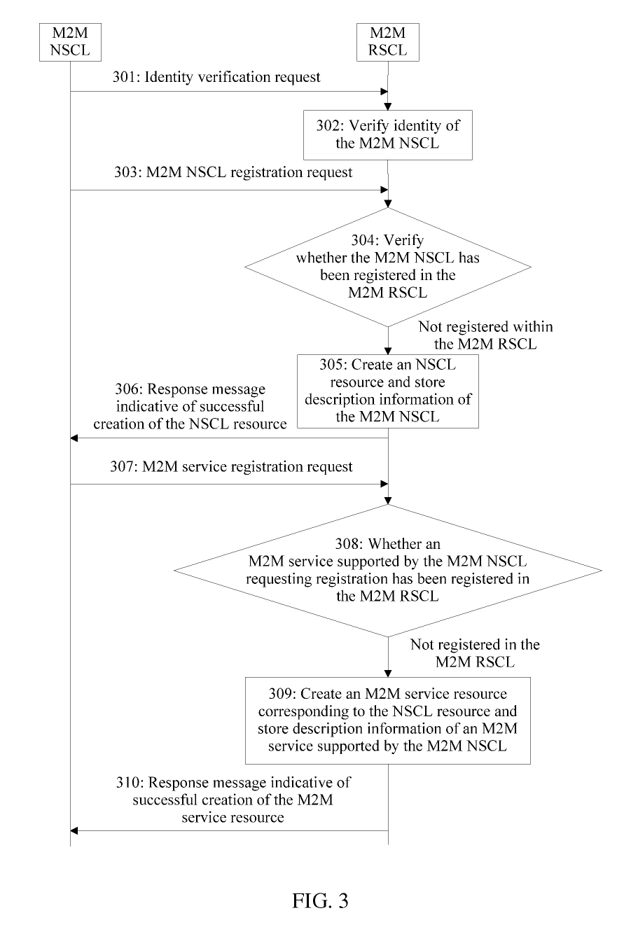

Referring to FIG. 3, the method for discovering an M2M service provided by an embodiment of the present invention may include the following operations:

Step 301: An M2M NSCL sends an identity verification request to an M2M RSCL, where the identify verification request includes identification information of the M2M NSCL.

Step 302: After receiving the identify verification request, the M2M RSCL verifies an identity of the M2M NSCL.

In specific implementation of the embodiment of the present invention, the M2M NSCL is statically preconfigured with information about an M2M RSCL that allows registration. Herein, the configured information about the M2M NSCL that allows registration includes at least the identification information of the M2M NSCL. After receiving the identify verification request, the M2M RSCL determines whether identification information of a locally stored M2M NSCL includes the identification information of the M2M NSCL. When the identification information of the M2M NSCL is locally stored on the M2M RSCL, it is determined that the identity of the M2M NSCL is authorized, the M2M NSCL is allowed to perform registration, and a verification success message is returned to the M2M NSCL. After receiving the verification success message, the M2M NSCL sends a registration request to the M2M RSCL.

Step 303: The M2M NSCL sends an M2M NSCL registration request to the M2M RSCL, and request creating of a first resource in the M2M RSCL, where the first resource in the embodiment of the present invention is an NSCL resource; that is, requesting creating of context information of the M2M NSCL in the M2M RSCL. Here, a POST (registration) path may be “/<sclBase>/scls/<nscl>”.

In the embodiment of the present invention, a message body of the M2M NSCL registration request carries description information of the M2M NSCL. Here, the description information of the M2M NSCL includes at least identification information of the M2M NSCL (nscl-ID), where the identification information of the M2M NSCL can include at least one of: an access URI, an NSCL identifier, and an IP address; while in specific implementation, in addition to the description information, the description information of the M2M NSCL further includes at least one of: a name of the M2M NSCL and information of a network domain to which the M2M NSCL belongs (M2M NSCL Domain information).

In addition, a message header of the M2M NSCL registration request further carries at least one of: address information and identification information of the M2M Registry RGC, where an M2M Register RGC corresponding to the address information or the identification information in the M2M RSCL specifically provides a registration service for the M2M NSCL.

The nscl-ID is used to identify the M2M NSCL and access URI information provides access information of the M2M NSCL, for example, an access path of the M2M NSCL.

Step 304: After receiving the M2M SCL registration request, the M2M RSCL verifies whether the M2M NSCL has been registered in the M2M RSCL.

If the M2M NSCL has been registered in the M2M RSCL, the M2M RSCL rejects the M2M SCL registration request and returns error information to the M2M NSCL, and the operation ends.

If the M2M NSCL has not been registered in the M2M RSCL, step 305 is performed.

Specifically, the verifying whether the M2M NSCL has been registered in the M2M RSCL may include: checking whether an NSCL resource identified by the nscl-ID exists in a <sclBase>/scls path; if exists, determining that the M2M NSCL has been registered in the M2M RSCL; otherwise, determining that the M2M NSCL has not been registered in the M2M RSCL.

Step 305: The M2M RSCL receives the M2M SCL registration request, creates the NSCL resource, and stores description information of the M2M NSCL; specifically, creates an NSCL resource sample in the <sclBase>/scls path. In the embodiment of the present invention, the created NSCL resource is identified by the nscl-ID.

Step 306: After successfully creating the NSCL resource identified by the nscl-ID, the M2M RSCL returns a response message indicative of successful creation of the NSCL resource to the M2M NSCL.

Step 307: After receiving the response message indicative of successful creation of the NSCL resource, the M2M NSCL sends an M2M service registration request to the M2M RSCL, requests for registering of information of the M2M service supported by the M2M NSCL with the M2M RSCL. Here, the POST path may specifically be “ksclBase>/sclsknscl>/applications”.

In the embodiment of the present invention, a message body of the M2M service registration request carries at least the description information of the M2M service supported by the M2M NSCL. Here, the description information of the M2M service includes at least the identification information of the M2M service (application identifier (APP-ID)). In specific implementation, the description information of the M2M service may further include at least one of the following service description: a name of the M2M service (APP-name), provider information (Service Provider) of the M2M service, a type (App-Type or vertical service type) of the M2M service, service area information (Location) of the M2M service, and quantity of service users of the M2M service and a billing standard of the M2M service.

In addition, a message header of the M2M service registration request carries at least one of: address information and identification information of the M2M Registry RGC, where the M2M Register RGC corresponding to the address information or the identification information in the M2M RSCL specifically provides the registration service for the M2M NSCL.

Step 308: After receiving the M2M service registration request, the M2M RSCL verifies whether the M2M service that requests for registration and is supported by the M2M NSCL has been registered with the M2M RSCL.

If the M2M service has been registered with the M2M RSCL, the M2M RSCL rejects the M2M service registration request and returns an error message to the M2M NSCL.

If the M2M service is not registered with the M2M RSCL, step 309 is performed.

Specifically, the verifying whether the M2M service that requests for registration and is supported by the M2M NSCL has been registered with the M2M RSCL may include: checking whether an APP-ID of the M2M service that requests for registration and is supported by the M2M NSCL exists in the <sclBase>/scls/<nscl>/applications path; if existed, it is determined that the M2M service that requests for registration and is supported by the M2M NSCL has been registered in the M2M RSCL; otherwise, it is determined that the M2M service that requests for registration and is supported by the M2M NSCL has not been registered in the M2M RSCL.

Step 309: The M2M RSCL receives the M2M service registration request, creates a second resource corresponding to the NSCL resource, where the second resource in the embodiment of the present invention is an M2M service resource, and stores the description information of the M2M service supported by the M2M NSCL, where the M2M service resource specifically may be identified by an M2M service identifier (APP-ID).

Specifically, the M2M RSCL creates the M2M service resource identified by the APP-ID in the <sclBase>/scls/<nscl>/applications path.

Step 310: After successfully creating the M2M service resource identified by the APP-ID, the M2M RSCL returns a response message indicative of successful creation of the M2M service resource to the M2M NSCL to inform the M2M NSCL that the M2M service supported by the M2M NSCL has been successfully registered with the M2M RSCL.

By performing the foregoing steps, the M2M NSCL registered with the M2M RSCL and the M2M service supported by the M2M NSCL can be visually embodied in a tree structure illustrated in FIG. 4 (M2M RSCL Tree).

In this way, after the M2M NSCL and the M2M service supported by the M2M NSCL are registered with the M2M RSCL, an M2M service requester such as an M2M Network Application (M2M NA), an M2M SCL, or an M2M user may discover the M2M service according to the M2M NSCL registered with the M2M RSCL and the M2M service supported by the M2M NSCL.

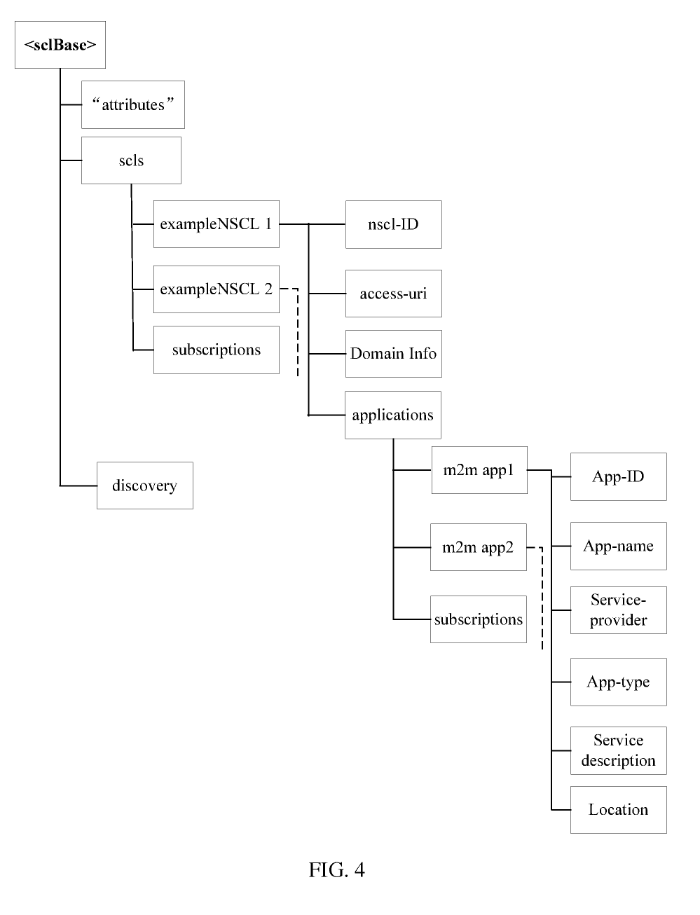

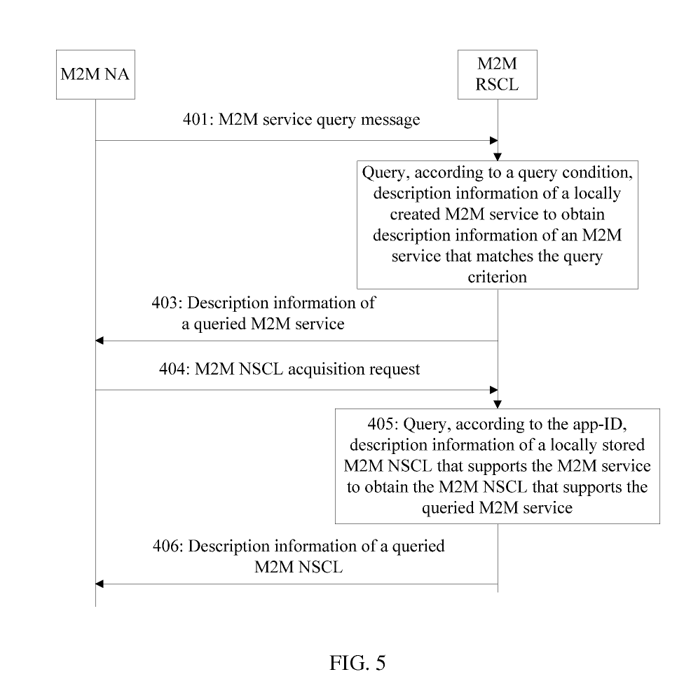

That the M2M application in the M2M service requester discovers the M2M service is used as an example in the following to describe a process of discovering an M2M service in detail. The process of discovering an M2M service by the M2M user or the M2M SCL is the same as this process. Referring to FIG. 5, a method for discovering an M2M service is provided, which may include the following operations:

Step 401: An M2M NA sends an M2M service query message to an M2M RSCL, and requests for querying of a required M2M service. A GET (query) path may specifically be “/<sclBase>/scls/nscl/applications”.

In the embodiment of the present invention, the message body of the M2M service query message carries the query criterion, where the query criterion is used to retrieve the required M2M service and here, the query criterion can include at least one of: a name of the M2M service for which query is requested, an identifier of the M2M service for which query is requested, provider information of the M2M service for which query is requested, a type of the M2M service for which query is requested, service area information of the M2M service for which query is requested, quantity of service users of the M2M service for which query is requested, and a billing standard of the M2M service for which query is requested.

In addition, a message header of the M2M service query message further carries at least one of: address information and identification information of an M2M Registry RAE, where the M2M Register RAE corresponding to the address information or the identification information in the M2M RSCL specifically provides a query service for the M2M NA.

Step 402: When receiving the M2M service query message, the M2M RSCL queries, according to a query criterion, description information of a locally created M2M service to obtain description information of an M2M service that matches the query criterion.

Step 403: The M2M RSCL returns description information of a queried M2M service to the M2M NA.

In the embodiment of the present invention, the description information of the M2M service includes at least identification information of the M2M service, where the identification information is used to identify the description information of the M2M service. In specific implementation, the description information of the M2M service can further include at least one of: the name of the M2M service, provider information of the M2M service, the type of the M2M service, service area information of the M2M service, quantity of service users of the M2M service, and the billing standard of the M2M service.

Step 404: After receiving the description information of the queried M2M service, the M2M NA sends an M2M NSCL acquisition request to the M2M RSCL, where the M2M NSCL acquisition request is used to request acquiring of the M2M NSCL that supports the queried M2M service. The M2M NSCL acquisition request carries the identification information of the queried M2M service (app-ID), and the GET (query) path can specifically be “/<sclBase>/scls”.

In the embodiment of the present invention, a message header of the M2M NSCL acquisition request further carries at least one of: the address information and identification information of the M2M Registry RAE, where the M2M Register RAE corresponding to the address information or the identification information in the M2M RSCL provides a query service for the M2M NA.

Step 405: After receiving the M2M NSCL acquisition request, the M2M RSCL queries, according to the app-ID, the description information of the locally stored M2M NSCL that supports the M2M service to obtain the M2M NSCL that supports the queried M2M service.

Step 406: The M2M RSCL returns the description information of the queried M2M NSCL to the M2M NA, so that the M2M NA acquires service data of the queried M2M service from the queried M2M NSCL or uses the queried M2M service.

The description information of the M2M NSCL includes at least the identification information of the queried M2M NSCL, and the identification information of the queried M2M NSCL may include at least one the following: the access URI information, an SCL identifier, and the IP address. In specific implementation, the description information of the M2M NSCL may further include at least one of: an M2M NSCL name, and information about an M2M network domain to which the M2M NSCL belongs.

In specific implementation of the embodiment of the present invention, the M2M RSCL and the M2M NSCL that supports the M2M service described above may be located in the same device, that is, the M2M RSCL and the M2M NSCL that supports the M2M service are co-located. In this situation, the M2M NA has already learnt an address of the M2M NSCL that supports the queried M2M service when sending the service query request to the M2M RSCL. Therefore, implementation of the step 404 to step 406 described above can be omitted.

In addition, in specific implementation of the embodiment of the present invention, after querying and obtaining the corresponding M2M service according to the received query criterion, the M2M RSCL may not need to wait for a next instruction from the M2M NSCL but may directly search for a directly searched M2M NSCL of the M2M service from the description information of the M2M NSCL that is locally stored and supports the M2M service. In this situation, the step 404 to step 406 described above can be substituted by the following operations: the M2M RSCL queries, according to the description information of the queried M2M service, the description information of the M2M NSCL that is locally stored and supports the M2M service to obtain the M2M NSCL that supports the queried M2M service, and returns the description information of the queried M2M service and the description information of the M2M NSCL that supports the queried M2M service to the M2M service requester.

By means of performing the foregoing operations, the M2M service requester can query the required M2M service and the M2M NSCL that supports the queried M2M service in the M2M NSCL registered with the M2M RSCL and the M2M service supported by the M2M NSCL; and after that, the M2M service requester can acquire data information of the queried M2M service and uses the queried M2M service on the M2M NSCL that supports the queried M2M service.

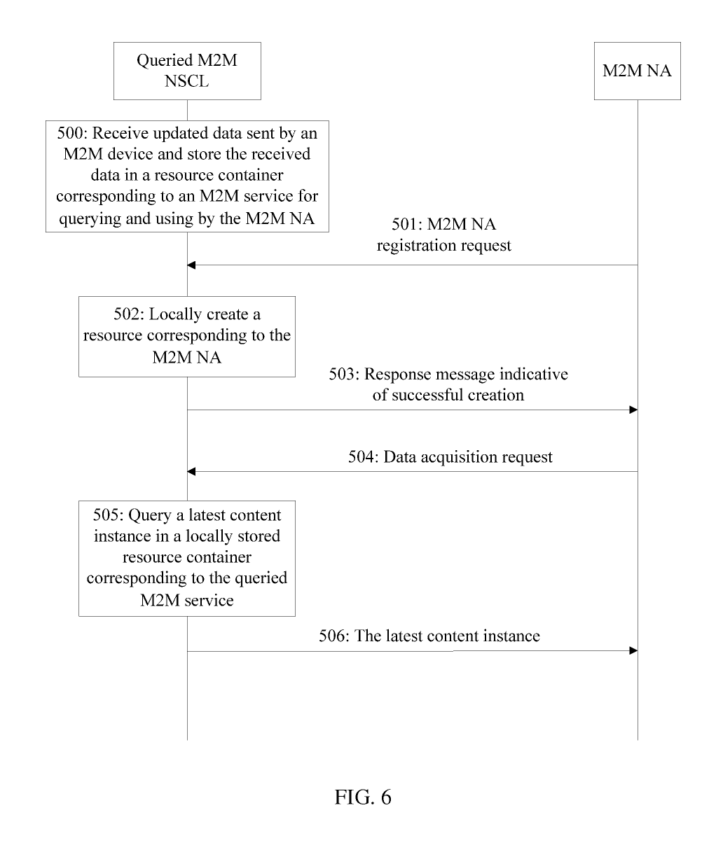

The following describes a method for acquiring the data information of the queried M2M service and using the queried M2M service by using an M2M application as an example. The method for acquiring the data information of the queried M2M service and using the queried M2M service by the M2M user or the M2M SCL is the same as this method. For the specific method, refer to FIG. 6, which includes the following operations.

Step 500: The queried M2M NSCL receives updated data sent by the M2M device and stores the received data in a resource container corresponding to the M2M service for querying and using by the M2M NA.

Step 501: Before acquiring the data information of the queried M2M service, the M2M NA sends an M2M NA registration request to the queried M2M NSCL, to register the queried M2M service for using, where a POST (registration) path is “nscl/applications/m2mNa” and an message header of the M2M NA registration request carries an IP address of an M2M NSCL1NAE.

Step 502: After receiving the M2M NA registration request, the queried M2M NSCL locally creates a resource corresponding to the M2M NA and uses the app-ID to identify the created resource.

Step 503: After successfully creating the resource corresponding to the M2M NA, the queried M2M NSCL returns a response message indicative of successful creation to the M2M

NA.

Step 504: The M2M NA sends a data acquisition (contentlnstance) request to the queried M2M NSCL, where a GET (acquisition) path is “nscl/applications/m2mAppl/containers/Container/contentInstances” and a request message header carries an IP address of an M2M NSCL NAE.

Step 505: After receiving a contentlnstance request from the M2M NA, the queried M2M NSCL queries a latest contentlnstance (contentInstance) in a locally stored resource container corresponding to the queried M2M service.

Step 506: The queried M2M NSCL sends the latest contentInstance to the M2M NA.

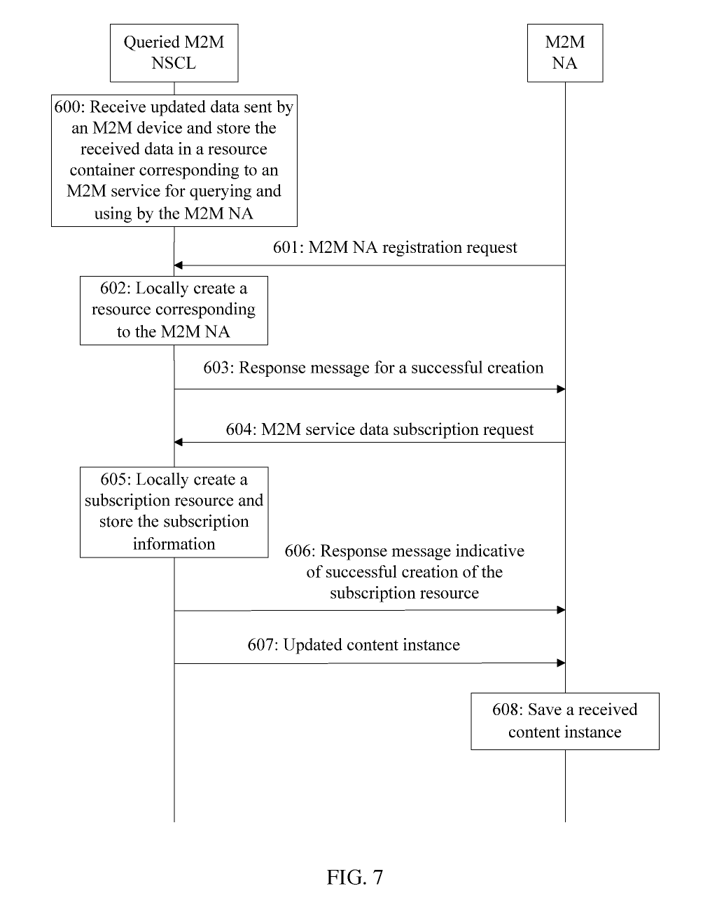

The foregoing is an implementation process of actively acquiring the data information of the queried M2M service by the M2M service requester. In specific implementation, the M2M service requester can further acquire the data information of the queried M2M service in a subscription manner. The following describes the method for acquiring the data information of the queried M2M service by using the M2M application as an example. The method for acquiring the data information of the queried M2M service by the M2M user is the same as this method. For a specific method, refer to FIG. 7, which includes the following operating steps.

For the implementation of step 600 to step 603, refer to the description corresponding to step 500 to step 503 respectively, which is not further described herein.

Step 604: The M2M NA sends an M2M service data subscription request to the queried M2M NSCL, where a POST path is nscl/applications/m2mAppl/containers/Container/contentInstances/subscription.

The M2M service data subscription information at least includes but is not limited to a subscription type (subscriptionType) and a subscription feedback address (callback URI).

Step 605: The queried M2M NSCL locally creates a subscription resource and stores the subscription information.

Step 606: After successfully creating the Subscription resource, the queried M2M NSCL returns a response message indicative of successful creation of the Subscription resource to the M2M NA.

Step 607: The queried M2M NSCL feeds back an updated contentlnstance to the M2M application or M2M user by using a subscription feedback address in the subscription information when the contentInstance in the locally stored resource container corresponding to the queried M2M service is updated.

Step 608: The M2M NA saves a received contentlnstance and confirms an M2M service data update with the queried M2M NSCL.

Beneficial effects achieved by the technical solutions the present invention are: when a plurality of different M2M NSCLs exist in a same M2M network domain or between different M2M network domains, the M2M NSCL and description information of an M2M service supported by the M2M NSCL can be registered with the M2M RSCL, so that an M2M user or an M2M application discovers a specific M2M service and an M2M NSCL that supports the specific M2M service according to the M2M NSCL and the description information of the M2M service supported by the M2M NSCL registered with the M2M RSCL, and may acquire data of the specific M2M service from the M2M NSCL that supports the specific M2M service.

### Embodiment 2

Referring to FIG. 8, an embodiment of the present invention provides a device for discovering an M2M service, where the device includes a receiver, a transmitter, a memory, and a processor.

In specific implementation of the embodiment of the present invention, the receiver is configured to receive a second device registration request sent by a second device, where the second device registration request carries description information of the second device; the processor is configured to create a first resource and store the description information of the second device in the memory; the transmitter is configured to return a response indicative of a registration success of the second device to the second device, so that the second device sends an M2M service registration request to the second device after receiving the response indicative of the registration success of the second device; accordingly, the receiver is further configured to receive the M2M service registration request, where the M2M service registration request carries description information of an M2M service supported by the second device; and the processor is further configured to create a second resource corresponding to the first resource and store the description information of the M2M service supported by the second device in the memory, so that an M2M service requester discovers the M2M service according to the description information of the second device and the description information of the M2M service supported by the second device.

A technical solution provided in the embodiment of the present invention may be applicable to any distributed computer system and non-computer scheduling system (such as a fleet management system, an automatic meter reading system, a health surveillance system, or an environmental monitoring system) where the M2M service is running, including a computer, a minicomputer, and a rack server.

Beneficial effects achieved in the embodiment of the present invention are: by means of receiving a second device registration request and an M2M service registration request sent by a second device and storing description information of the second device and description information of an M2M service supported by the second device, an M2M service requester (an M2M user, an M2M application, or a first device) discovers the M2M service according to the description information of the second device and the description information of the M2M service supported by the second device stored by the first device.

### Embodiment 3

Referring to FIG. 9, an embodiment of the present invention provides a device for discovering an M2M service. The device is specifically the same as the first device in Embodiment 1 of the method and may include: a first receiving module 701, a first resource creating module 702, a sending module 703, a second receiving module 704, and a second resource creating module 705.

The first receiving module 701 is configured to receive a second device registration request sent by a second device, where the second device registration request carries description information of the second device.

In the embodiment of the present invention, the description information of the second device may include identification information of the second device, where the identification information includes at least one of: access URI information, a device identifier, and an IP address.

In specific implementation, the description information of the second device further includes at least one of: a name of the second device and information about an M2M network domain to which the second device belongs.

The first resource creating module 702 is configured to create a first resource and store the description information of the second device.

The sending module 703 is configured to return a response indicative of a registration success of the second device to the second device, so that the second device sends an M2M service registration request to the second device after receiving the response indicative of the registration success of the second device.

The second receiving module 704 is configured to receive the M2M service registration request, where the M2M service registration request carries description information of an M2M service supported by the second device.

In the embodiment of the present invention, the description information of the M2M service includes at least identification information of the M2M service.

In specific implementation, the description information of the M2M service further includes at least one of: a name of the M2M service, provider information of the M2M service, a type of the M2M service, service area information of the M2M service, quantity of service users of the M2M service, and a billing standard of the M2M service.

The second resource creating module 705 is configured to create a second resource corresponding to the first resource and store the description information of the M2M service supported by the second device, so that an M2M service requester discovers the M2M service according to the description information of the second device and the description information of the M2M service supported by the second device.

Beneficial effects achieved in the embodiment of the present invention are: by means of receiving a second device registration request and an M2M service registration request sent by a second device and storing description information of the second device and description information of an M2M service supported by the second device, an M2M service requester (an M2M user, an M2M application, or a first device) discovers an M2M service according to the description information of the second device and the description information of the M2M service supported by the second device stored by the first device.

### Embodiment 4

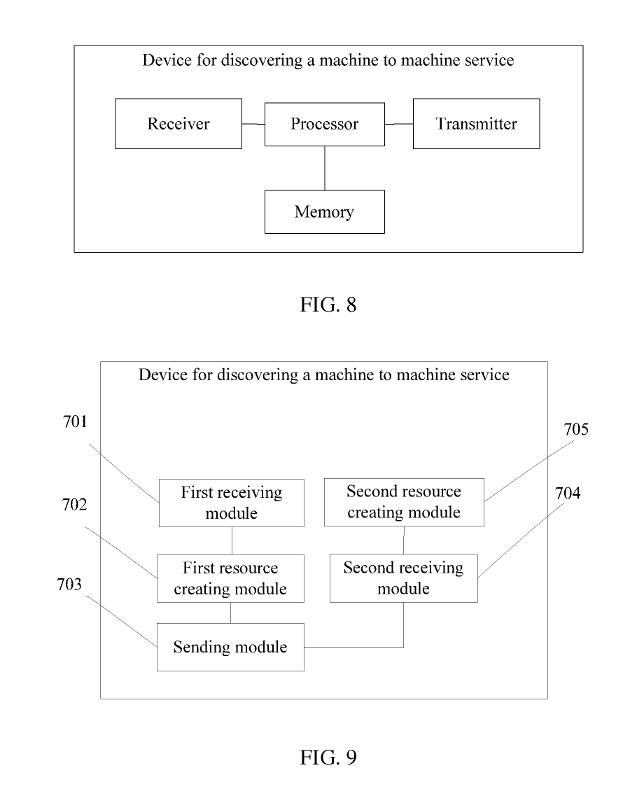

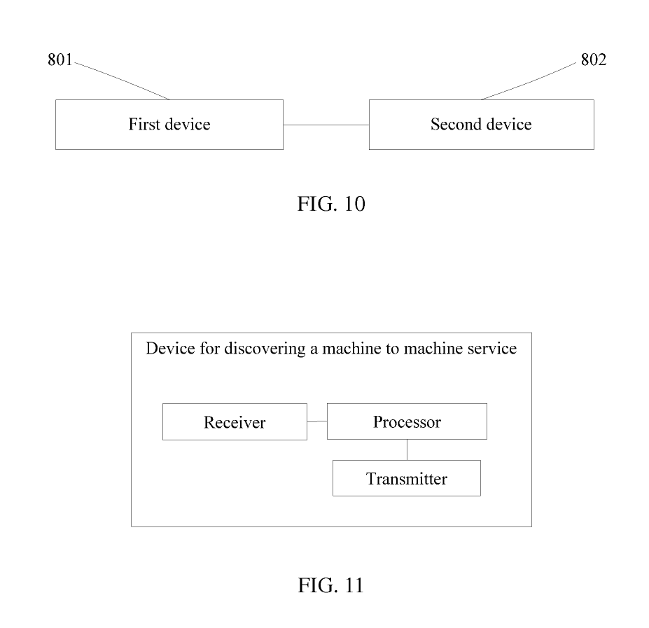

Referring to FIG. 10, an embodiment of the present invention provides a system for discovering an M2M service, including a first device 801 and a second device 802.

The second device 802 is configured to send a second device registration request to the first device 801, where the second device registration request carries description information of the second device 802.

The first device 801 is configured to create a first resource when receiving the second device registration request, store the description information of the second device 802, and return a response indicative of a registration success of the second device to the second device 802.

The second device 802 is further configured to send an M2M service registration request to the first device 801 after receiving the response indicative of the registration success of the second device, where the M2M service registration request carries description information of an M2M service supported by the second device 802.

The first device 801 is configured to: when receiving the M2M service registration request, create a second resource corresponding to the first resource, and store the description information of the M2M service supported by the second device 802, so that an M2M service requester discovers the M2M service according to the description information of the second device 802 and the description information of the M2M service supported by the second device 802.

For details about a structure of the first device 801, refer to the structure of the device in Embodiment 3 of the present invention, which is not further described herein.

Beneficial effects achieved in the embodiment of the present invention are: by means of receiving a second device registration request and an M2M service registration request sent by a second device and storing description information of the second device and description information of an M2M service supported by the second device, an M2M service requester (an M2M user, an M2M application, or a first device) discovers an M2M service according to the description information of the second device and the description information of the M2M service supported by the second device stored by the first device.

### Embodiment 5

Referring to FIG. 11, an embodiment of the present invention further provides a device for discovering an M2M service, where the device may specifically include a receiver, a processor, and a transmitter.

The receiver is configured to receive a service query message sent by an M2M service requester, where the service query message carries a query criterion.

The processor is configured to query, according to the query criterion, description information of a locally stored M2M service to obtain description information of an M2M service that matches the query criterion.

The transmitter is configured to return at least one of description information of a queried M2M service and description information of a second device that supports the queried M2M service to the M2M service requester, so that the M2M service requester acquires service data of the queried M2M service from the second device or uses the queried M2M service.

Beneficial effects achieved in the embodiment of the present invention are: description information of a locally stored M2M service is queried according to a query criterion in a service query message sent by an M2M service requester, and description information of an M2M service that matches the query criterion is obtained; and then, description information of the queried M2M service and description of the second device that supports the queried M2M service are returned to the M2M service requester, so that the M2M service requester can acquire service data of the queried M2M service from a queried M2M NSCL.

### Embodiment 6

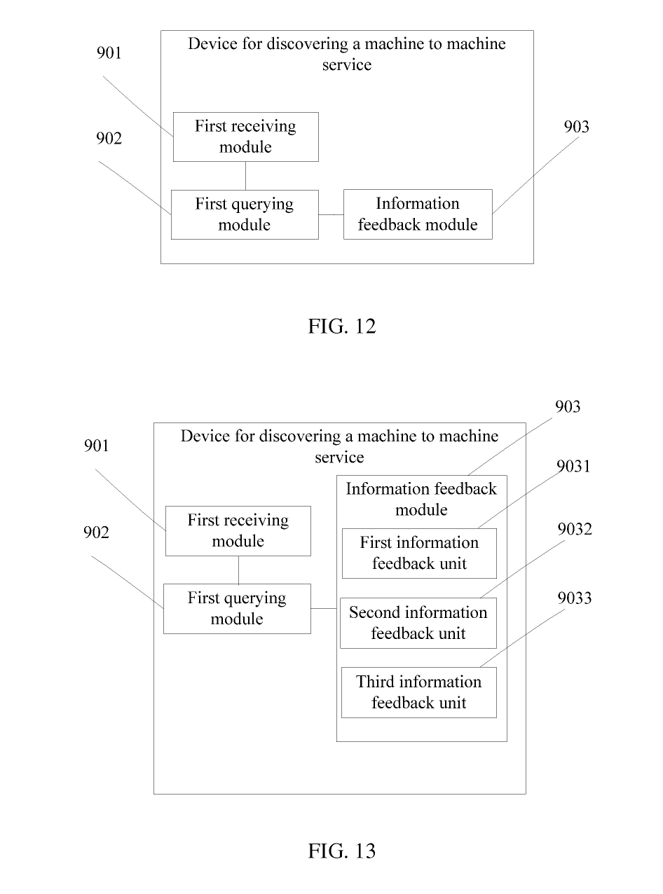

Referring to FIG. 12, an embodiment of the present invention provides a device for discovering an M2M service. The device is specifically the same as the first device in Embodiment 1 of the method and may include: a first receiving module 901, a first querying module 902, and an information feedback module 903.

The first receiving module 901 is configured to receive a service query message sent by an M2M service requester, where the service query message carries a query criterion.

In the embodiment of the present invention, the query criterion includes at least one of: a name of the M2M service for which query is requested, an identifier of the M2M service for which query is requested, provider information of the M2M service for which query is requested, a type of the M2M service for which query is requested, service area information of the M2M service for which query is requested, quantity of service users of the M2M service for which query is requested, and a billing standard of the M2M service for which query is requested.

The first querying module 902 is configured to query, according to the query criterion, description information of a locally stored M2M service to obtain description information of an M2M service that matches the query criterion.

In the embodiment of the present invention, the description information of the M2M service includes at least identification information of the M2M service. In specific implementation, the description information of the M2M service further includes at least one of: a name of the M2M service, provider information of the M2M service, a type of the M2M service, service area information of the M2M service, quantity of service users of the M2M service, and a billing standard of the M2M service.

The information feedback module 903 is configured to return at least one of description information of a queried M2M service and description information of a second device that supports the queried M2M service to the M2M service requester, so that the M2M service requester acquires service data of the queried M2M service from the second device or uses the queried M2M service.

In the embodiment of the present invention, the description information of the second device includes identification information of the second device, where the identification information includes at least one of: access URI information, an SCL identifier, and an IP address. In specific implementation, the description information of the second device may further include at least one of: a name of the second device, and information about an M2M network domain to which the second device belongs.

Further, referring to FIG. 13, the information feedback module 903 shown in FIG. 12 in the embodiment of the present invention may include: a first information feedback unit 9031 configured to query, according to the description information of the queried M2M service, the description information of the locally stored second device that supports the M2M service to obtain the second device that supports the queried M2M service, and then return the description information of the queried M2M service and the description information of the second device that supports the queried M2M service to the M2M service requester; alternatively, a second information feedback unit 9032 configured to: when the second device that supports the M2M service and the first device are located within the same device, the first device directly returns the description information of the queried M2M service to the M2M service requester; alternatively, a third information feedback unit 9033 configured to: return the description information of the queried M2M service to the M2M service requester, so that the second device sends a second device acquiring request to the first device after receiving the description information of the queried M2M service; receive the second device acquiring request, where the second device acquiring request is used to acquire the second device that supports the queried M2M service, and the second device acquiring request carries identification information of the queried M2M service; query, according to the identification information, locally stored description information of the second device that supports the M2M service to obtain the second device that supports the queried M2M service; and return the description information of the second device that supports the queried M2M service to the M2M service requester.

Beneficial effects achieved in the embodiment of the present invention are: description information of a locally stored M2M service is queried according to a query criterion in a service query message sent by an M2M service requester, and description information of an M2M service that matches the query criterion is obtained; and then, description information of a queried M2M service and description information of a second device that supports the queried M2M service are returned to the M2M service requester, so that the M2M service requester can acquire service data of the queried M2M service from a queried M2M NSCL.

### Embodiment 7

Referring to FIG. 14, a system for discovering an M2M service is provided, where the system includes an M2M service requester A1 and a first device A2, and the M2M service requester A1 may specifically include an M2M application, an M2M SCL, or an M2M user.

The M2M service requester A1 is configured to send a service query message to the first device A2, where the service query message carries a query criterion.

The first device A2 is configured to query, according to the query criterion, description information of a locally stored M2M service to obtain description information of an M2M service that matches the query criterion, and return at least one of: description information of a queried M2M service and description information of a second device that supports the queried M2M service to the M2M service requester A1, so that the M2M service requester A1 acquires service data of the queried M2M service from the second device or uses the queried M2M service.

For details about a structure of the first device A2, refer to the structure of the device in Embodiment 6 of the present invention, which is not further described herein.

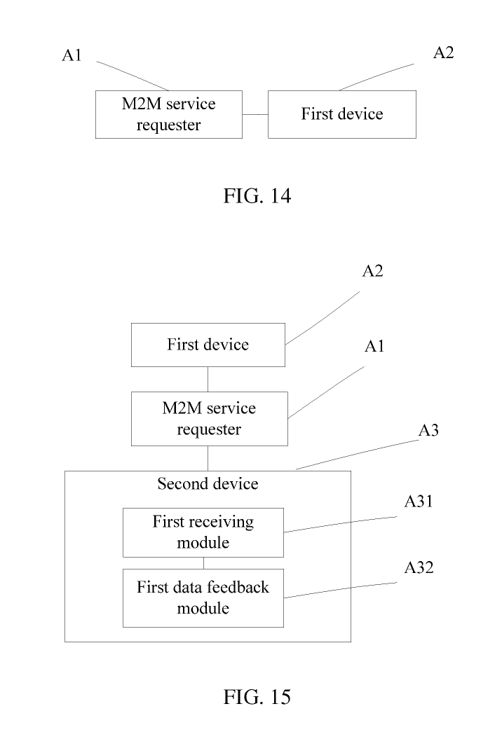

Referring to FIG. 15, the system shown in FIG. 14 in the embodiment of the present invention further includes a second device A3, where the second device A3 includes: a first receiving module A31 configured to receive an M2M service data acquiring request sent by the M2M service requester A1; and a first data feedback module A32 configured to query a latest contentlnstance in a locally stored resource container corresponding to the queried M2M service, and send a latest contentlnstance to the M2M service requester A1.

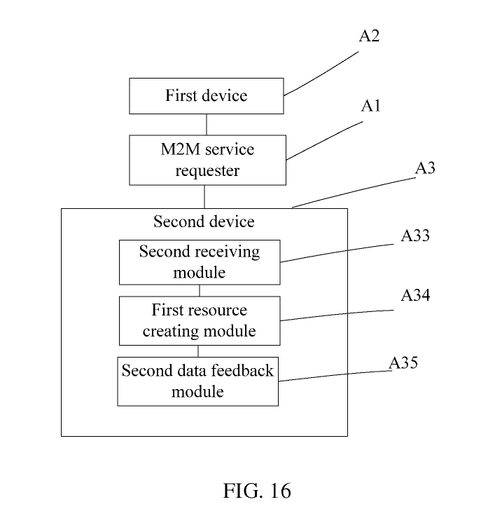

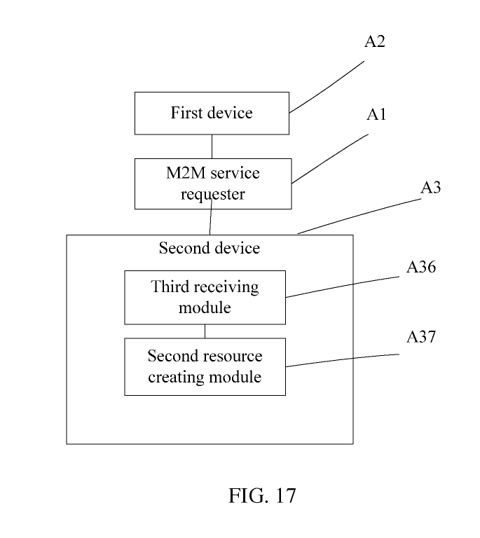

Further, referring to FIG. 16, the system shown in FIG. 14 in the embodiment of the present invention further includes a second device A3, where the second device A3 includes: a second receiving module A33 configured to receive an M2M service data subscription request sent by the M2M service requester A1, where the M2M service data subscription request carries subscription information; a first resource creating module A34 configured to create a subscription resource to store the subscription information; and a second data feedback module A35 configured to feed back an updated contentlnstance to the M2M service requester A1 by using a subscription feedback address in the subscription information when the contentlnstance in the locally stored resource container corresponding to the queried M2M service is updated.

Further, referring to FIG. 17, the system shown in FIG. 14 in the embodiment of the present invention further includes a second device A3, where the second device A3 includes: a third receiving module A36 configured to receive a registration request sent by the M2M service requester; and a second resource creating module A37 configured to locally create a resource corresponding to the M2M service requester.

Beneficial effects achieved by the technical solutions of the present invention are: description information of a locally stored M2M service is queried according to a query criterion in a service query message sent by an M2M service requester, and description information of an M2M service that matches the query criterion is obtained; and then, description information of a queried M2M service and description of a second device that supports the queried M2M service are returned to the M2M service requester, so that the M2M service requester can acquire service data of the queried M2M service from a queried M2M NSCL.

It should be noted that when the device provided in the foregoing embodiment discovers an M2M service, the division of the above functional modules is used as an example for description. In the actual applications, the above functions may be implemented by different functional modules according to an actual need, that is, different functional modules are divided according to an internal structure of a receiver to complete the above all or some functions. In addition, the device provided in the embodiment is based on the same conception as the method for discovering an M2M service in the foregoing embodiment. The specific implementation of the device is detailed in the method embodiment, and is not repeated herein.

The sequence numbers of the above embodiments of the present invention are used merely for description, and do not represent the preference of the embodiments.

A person of ordinary skill in the art may understand that all or a part of the steps of the embodiments may be implemented by hardware or a program instructing relevant hardware. The program may be stored in a computer readable storage medium. The storage medium may include: a read-only memory, a magnetic disk, or an optical disc.

The foregoing descriptions are merely exemplary embodiments of the present invention, but are not intended to limit the present invention. Any modification, equivalent replacement, and improvement made without departing from the spirit and principle of the present invention shall fall within the protection scope of the present invention.

What is claimed is:

1. A method for discovering a machine to machine (M2M) service, comprising:
receiving, by a first device, a service query message sent by an M2M service requester, wherein the service query message carries a query criterion;
querying, by the first device and according to the query criterion, description information of a locally stored M2M service to obtain description information of an M2M service that matches the query criterion; and
returning, by the first device, at least one of description information of the queried M2M service and description information of the second device that supports the queried M2M service to the M2M service requester such that the M2M service requester acquires service data of the queried M2M service from the second device or uses the queried M2M service.

2. The method according to claim 1, wherein returning, by the first device, the at least one of the description information of the queried M2M service and the description information of the second device that supports the queried M2M service to the M2M service requester comprises querying, by the first device and according to the description information of the queried M2M service, description information of a locally stored second device that supports the M2M service to obtain the second device that supports the queried M2M service, and then returning the description information of the queried M2M service and the description information of the second device that supports the queried M2M service to the M2M service requester.

3. The method according to claim 1, wherein returning, by the first device, the at least one of the description information of the queried M2M service and the description information of the second device that supports the queried M2M service to the M2M service requester comprises directly returning, by the first device, the description information of the queried M2M service to the M2M service requester when the second device that supports the M2M service and the first device are located in a same device.

4. The method according to claim 1, wherein returning, by the first device, the at least one of the description information of the queried M2M service and the description information of the second device that supports the queried M2M service to the M2M service requester comprises:
returning the description information of the queried M2M service to the M2M service requester such that the second device sends a second device acquiring request to the first device after receiving the description information of the queried M2M service;
receiving the second device acquiring request, wherein the second device acquiring request is used to request the second device that supports the queried M2M service, and the second device acquiring request carries identification information of the queried M2M service;
querying, according to the identification information, description information of a locally stored second device that supports the M2M service to obtain the second device that supports the queried M2M service; and
returning the description information of the second device that supports the queried M2M service to the M2M service requester.

5. The method according to claim 1, wherein the query criterion comprises at least one of a name of an M2M service for which query is requested, an identifier of the M2M service for which query is requested, provider information of the M2M service for which query is requested, a type of the M2M service for which query is requested, service area information of the M2M service for which query is requested, quantity of service users of the M2M service for which query is requested, and a billing standard of the M2M service for which query is requested.

6. The method according to claim 1, wherein the description information of the M2M service comprises identification information of the M2M service.

7. The method according to claim 6, wherein the description information of the M2M service further comprises at least one of a name of the M2M service, provider information of the M2M service, a type of the M2M service, service area information of the M2M service, quantity of service users of the M2M service, and a billing standard of the M2M service.

8. The method according to claim 1, wherein the description information of the second device comprises at least identification information of the second device, and the identification information comprises at least one of access uniform resource indicator (URI) information, a service capabilities layer (SCL) identifier, and an Internet Protocol (IP) address.

9. The method according to claim 8, wherein the description information of the second device further comprises at least one of a name of the second device and information about an M2M network domain to which the second device belongs.

10. The method according to claim 1, wherein the service query message further carries at least one of address information and identification information of an M2M register machine application enablement registry application enablement (RAE) capability layer.

11. The method according to claim 1, wherein acquiring, by the M2M service requester, service data of the queried M2M service from the second device or using the queried M2M service comprises:
receiving, by the second device, an M2M service data acquiring request sent by the M2M service requester; and
querying, by the second device, a latest contentlnstance in a locally stored resource container corresponding to the queried M2M service; and
sending the latest contentlnstance to the M2M service requester.

12. The method according to claim 1, wherein acquiring, by the M2M service requester, the service data of the queried M2M service from the second device or using the queried M2M service comprises:
receiving, by the second device, an M2M service data subscription request sent by the M2M service requester, wherein the M2M service data subscription request carries subscription information;
creating, by the second device, a subscription resource to store the subscription information; and
feeding back, by the second device, an updated contentlnstance to the M2M service requester by using a subscription feedback address in the subscription information when the contentlnstance in the locally stored resource container corresponding to the queried M2M service is updated.

13. The method according to claim 11, wherein before acquiring, by the M2M service requester, the service data of the queried M2M service from the second device or using the queried M2M service, the method further comprises:
receiving, by the second device, a registration request sent by the M2M service requester; and
locally creating, by the second device, a resource corresponding to the M2M service requester.

14. The method according to claim 12, wherein before acquiring, by the M2M service requester, the service data of the queried M2M service from the second device or using the queried M2M service, the method further comprises:
receiving, by the second device, a registration request sent by the M2M service requester; and
locally creating, by the second device, a resource corresponding to the M2M service requester.

15. A device for discovering a machine to machine (M2M) service, comprising:
a first receiving module;
a first querying module; and
an information feedback module,
wherein the first receiving module is configured to receive a service query message sent by an M2M service requester, and the service query message carries a query criterion,
wherein the first querying module is configured to query, according to the query criterion, description information of a locally stored M2M service to obtain description information of an M2M service that matches the query criterion, and
wherein the information feedback module is configured to return at least one of description information of the queried M2M service and description information of the second device that supports the queried M2M service to the M2M service requester such that the M2M service requester acquires service data of the queried M2M service from the second device or uses the queried M2M service.

16. The device according to claim 15, wherein the information feedback module comprises a first information feedback unit configured to query, according to the description information of the queried M2M service, the description information of the locally stored second device that supports the M2M service to obtain the second device that supports the queried M2M service, and then return the description information of the queried M2M service and the description information of the second device that supports the queried M2M service to the M2M service requester.

17. The device according to claim 15, wherein the information feedback module comprises a second information feedback unit configured to directly return the description information of the queried M2M service to the M2M service requester when the second device that supports the M2M service and the first device are located in a same device.

18. The device according to claim 15, wherein the information feedback module comprises a third information feedback unit configured to:
return the description information of the queried M2M service to the M2M service requester such that the second device sends a second device acquiring request to the first device after receiving the description information of the queried M2M service;
receive the second device acquiring request, wherein the second device acquiring request is used to request and obtain the second device that supports the queried M2M service, and the second device acquiring request carries identification information of the queried M2M service;
query, according to the identification information, description information of a locally stored second device that supports the M2M service to obtain the second device that supports the queried M2M service; and
return the description information of the second device that supports the queried M2M service to the M2M service requester.

19. A system for discovering a machine to machine (M2M) service, comprising:
an M2M service requester; and
a first device,
wherein the M2M service requester is configured to send a service query message to the first device, and the service query message carries a query criterion, and
wherein the first device is configured to query, according to the query criterion, description information of a locally stored M2M service to obtain the description information of an M2M service that matches the query criterion, and return at least one of description information of the queried M2M service and description information of a second device that supports the queried M2M service to the M2M service requester such that the M2M service requester acquires service data of the queried M2M service from the second device or uses the queried M2M service.

20. The system according to claim 19, further comprising the second device, wherein the second device comprises:
a first receiving module configured to receive an M2M service data acquiring request sent by the M2M service requester; and
a first data feedback module configured to query a latest contentlnstance in a locally stored resource container corresponding to the queried M2M service, and send the latest contentlnstance to the M2M service requester.

21. The system according to claim 19, further comprising the second device, wherein the second device comprises:
a second receiving module configured to receive an M2M service data subscription request sent by the M2M service requester, and the M2M service data subscription request carries subscription information;
a first resource creating module configured to create a subscription resource to store the subscription information; and
a second data feedback module configured to feed back an updated contentlnstance to the M2M service requester by using a subscription feedback address in the subscription information when a contentlnstance in a locally stored resource container corresponding to the queried M2M service is updated.

22. The system according to claim 19, further comprising the second device, wherein the second device comprises:
a third receiving module configured to receive a registration request sent by the M2M service requester; and
a second resource creating module configured to locally create a resource corresponding to the M2M service requester.
